(19) United States
(12) Patent Application Publication
(10) Pub. No.: US 2007/0040054 A1
(43) Pub. Date: Feb. 22, 2007

(54) Showerhead faceplate and assembly

(76) Inventor: Yaron Farzan, Tel Aviv (IL)

Correspondence Address: Yaron Farzan, Shlomo Hamelekh 6, Tel Aviv, 64377, IL

(21) Appl. No.: 11/377,123

(22) Filed: Mar. 17, 2006

(30) Foreign Application Priority Data
Aug. 22, 2005 (IL) 167603

(51) Int. Cl. B05B 1/14

(52) U.S. Cl. 239/548

(57) ABSTRACT

A showerhead faceplate comprising a multitude of spray holes, a convex face, a drain hole and a drain hole sealing apparatus to seal and open said drain hole to allow discharge of water or other liquids trapped inside showerhead chamber, thus decreasing mineral buildup inside showerhead chamber and spray holes.

### BACKGROUND

The purpose of this invention is to allow liquid to discharge from showerhead chamber so as to decrease mineral buildup inside showerhead chamber and shower spray holes.

It is generally believed that mineral buildup in showerheads is caused mainly by water flowing through the spray holes. However, most of the mineral buildup is actually caused by water trapped inside the showerhead chamber. Water gets trapped inside showerhead chamber after water flow is shut. Not all the trapped water is discharged through the spray holes after a shower. If the trapped water is not discharged, water reservoirs inside the showerhead chamber and deposits minerals within and around the showerhead chamber and spray holes.

Current inventions allow removal or partial removal of mineral buildup in showerhead spray holes, focusing mainly on removing buildup from spray holes after buildup has accumulated. For instance, one invention incorporates hollow rubber studs that are attached to the mouths of the showerhead spray holes and that can be bent to break up said mineral buildup. However, these hollow rubber studs are hard and time-consuming to clean, and a showerhead apparatus incorporating these studs requires complex assembly and are more expensive to produce. A hard poker that is inserted through the spray holes is another option for removing said mineral buildup. Several products exist on the market, which come in powder or liquid form, and which are applied onto the showerhead faceplate and dissolve the mineral buildup. These products are usually chemicals that can be dangerous when touched and/or inhaled. Another way to discharge water trapped inside showerhead chamber is to unscrew the threaded ring that secures the showerhead faceplate to the showerhead handle. However, this method is not as efficient as simply pulling on a valve.

The present invention will decrease the need for and frequency of removing mineral buildup inside showerheads and showerhead spray holes, as compared to the products now available on the market. The time-consuming task of breaking up mineral buildup in rubber studs is eliminated. There is no need for an additional tool, such as a poker, for removing the mineral buildup. Frequency and quantity in messing around with dangerous chemicals in liquid or powder form to remove mineral buildup is greatly decreased, as significantly less mineral buildup accumulates. The present invention is easy and safe for use by people of almost all ages.

As we all know, the cleaner the showerhead spray holes, the more quality showers we take. Mineral buildup in showerheads accumulates during and, especially, after each shower. When the mineral buildup does not get the opportunity to accumulate, the spray holes remain clear. Many of us have had to put up with clogged or partially-clogged showerhead spray holes that create sharp and/or misdirected water flow, which make for an uncomfortable shower experience. This invention will provide the most enjoyable showering experience by facilitating free and even flow of liquid through shower spray holes for a longer period of time.

The present invention will increase longevity of showerhead faceplates and connected showerhead apparatuses. Many times, complete showerhead sets are thrown away just because the mineral buildup has clogged the spray holes and people do not want to bother with cleaning it out. By significantly decreasing the mineral buildup in the showerhead chamber through allowing the water to discharge on a regular basis, preferably after each shower, the spray holes take a much longer time to clog. Thus, the showerhead remains functionable for a longer period of time, saving money and the time and hassle of shopping for a new showerhead.

The present invention is also environmentally-friendly as less chemicals are used in maintaining it and as less junk is created by its increased longevity.

### SUMMARY OF THE INVENTION

The device of the present invention is a showerhead faceplate with a multitude of spray holes, comprising a convex face that allows liquid trapped inside showerhead chamber to reservoir, a drain hole to allow discharge of liquid trapped inside showerhead chamber, and a drain hole sealing apparatus to seal and open said drain hole.
a) The showerhead faceplate with a multitude of spray holes can come in the shape that fits a standard showerhead, which is usually round. In the preferred embodiment, the showerhead faceplate is round. Said showerhead faceplate is preferably made of hard plastic, but can be made of any non-corrosive material. In the preferred embodiment, a threaded ring secures said showerhead faceplate to showerhead handle and a ring stopper is placed between showerhead faceplate and showerhead handle to prevent leakage. In another embodiment, showerhead faceplate can be snapped-on to showerhead handle. In yet another embodiment, showerhead faceplate can form an integral, non-separate part of showerhead handle.
b) The convex face of the showerhead faceplate allows the liquid trapped inside the showerhead chamber to reservoir, which allows a most complete discharge of said liquid. The deepest part of the convex face can be located at any area of the showerhead faceplate. In the preferred embodiment, the convexity is deepest at center of the showerhead faceplate.
c) The drain hole of the showerhead faceplate is located at the deepest part of said convex face to allow liquid trapped inside showerhead chamber to discharge most completely when showerhead faceplate drain hole is open. Said drain hole can come in any shape, such as a rectangle, a square, a circle, a triangle, or any other geometric or organic shape, such as animal or novelty shapes, etc. In the preferred embodiment, the shape of the showerhead faceplate drain hole is round. In another embodiment, the showerhead faceplate drain hole can be threaded in order to allow a threaded drain hole sealing apparatus to be screwed into it.
d) The drain hole sealing apparatus of the showerhead faceplate can come in any shape, as long as it seals said drain hole. After a shower or any use of the device when attached to a showering device, the drain hole sealing apparatus can be removed from showerhead faceplate drain hole to allow discharge of liquid trapped inside showerhead chamber. Thereafter, said drain hole sealing apparatus can be reinstalled into said drain hole in order maintain comfortable water pressure and free and even flow through spray holes during a shower or use of the showerhead faceplate. In the preferred embodiment, said drain hole sealing apparatus is a rubber valve attached to the showerhead faceplate that is equipped with a pull tab for easy opening, and is fully detachable. In the preferred embodiment, the drain hole sealing apparatus is firmly but not permanently attached to the showerhead faceplate; in other embodiments it can form a separate component. Another embodiment of a drain hole sealing apparatus is in the form of a threaded apparatus that can be screwed into a threaded showerhead faceplate drain hole. Yet another embodiment of a drain hole sealing apparatus can come in cork-like or plug-like forms. The drain hole sealing apparatus may be reinstalled immediately onto showerhead faceplate drain hole or left ajar until next use of showerhead faceplate, as desired.

The objectives of this invention are:
1) to decrease mineral buildup inside showerhead faceplates, showerhead chambers and showerhead spray holes;
2) to decrease the use of dangerous chemicals for removing mineral buildup inside showerhead faceplates, showerhead chambers and showerhead spray holes;
3) to provide the most enjoyable showering experience by facilitating full and even flow of liquid through shower spray holes;
4) to increase longevity of showerhead faceplate and connected showerhead apparatuses.

These features of the device of the present invention will be better understood and appreciated from a reading of the following descriptions with reference to the accompanying drawings.

### BRIEF DESCRIPTION OF THE DRAWINGS

FIG. 1 is general view A of the preferred embodiment of a showerhead faceplate.

FIG. 2 is general view B of the preferred embodiment of a showerhead faceplate.

FIG. 3 is general view C of the preferred embodiment of a showerhead faceplate.

FIG. 4 is a front (exterior) view of the preferred embodiment of a showerhead faceplate.

FIG. 5 is a rear (interior) view of the preferred embodiment of a showerhead faceplate.

FIG. 6 is a side view of the preferred embodiment of a showerhead faceplate.

FIG. 7 is another side view of the preferred embodiment of a showerhead faceplate.

FIG. 8 is a general view of the preferred embodiment of a showerhead faceplate together with the separated components of a showerhead set.

FIG. 9 is a general view of the preferred embodiment of a showerhead faceplate assembled with the components of a showerhead set.

FIG. 10 is a general view of the preferred embodiment of a showerhead faceplate being used on showerhead set during a shower.

FIG. 11 is a general view of the preferred embodiment of a showerhead faceplate being used on showerhead set to allow liquid to discharge from showerhead chamber.

### DETAILED DESCRIPTION OF THE DRAWINGS

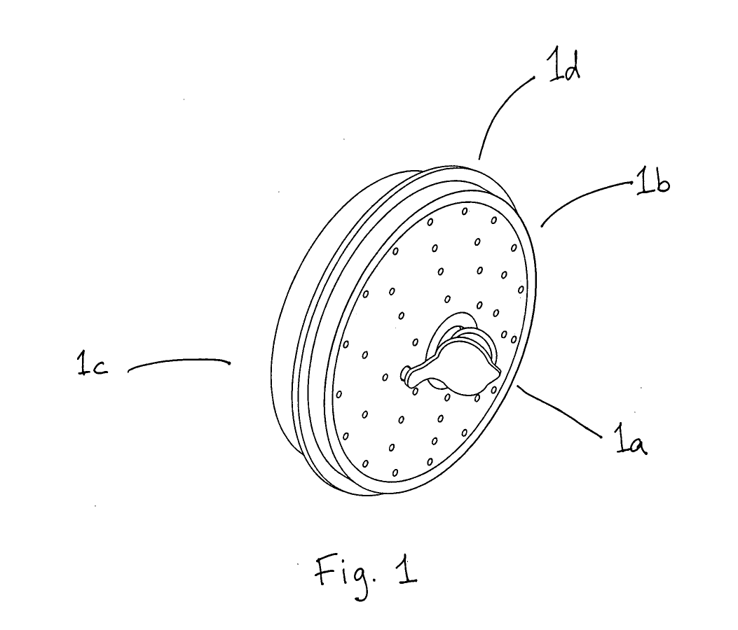

The general view of the preferred embodiment in FIG. 1 shows drain hole sealing apparatus 1a in an opened position firmly attached 1c to showerhead faceplate. Drain hole 1b and spray holes 1d are visible.

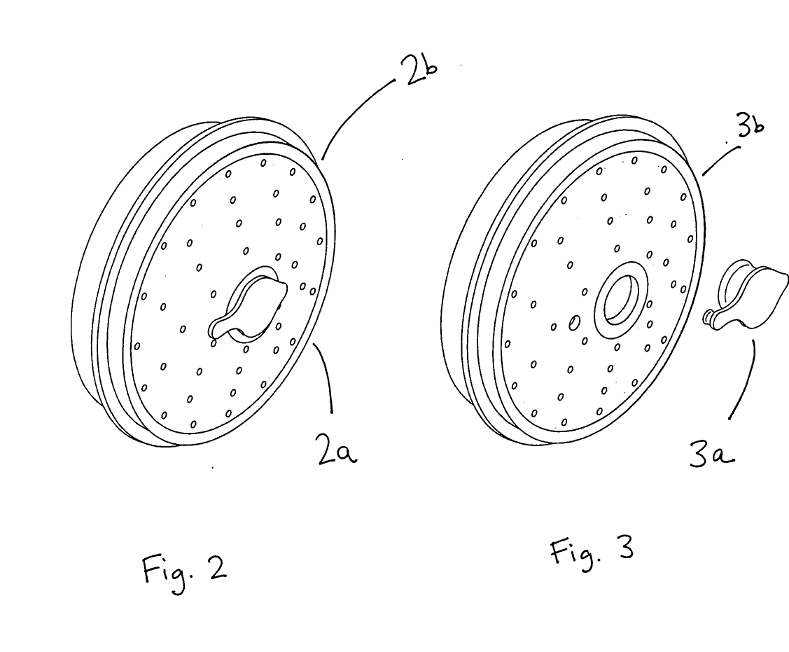

The general view of the preferred embodiment in FIG. 2 shows showerhead faceplate drain hole sealing apparatus 2a in the installed position, thereby sealing showerhead faceplate drain hole 2b.

The general view of the preferred embodiment in FIG. 3 shows showerhead faceplate drain hole sealing apparatus 3a as being completely detachable from showerhead faceplate. Drain hole 3b is visible.

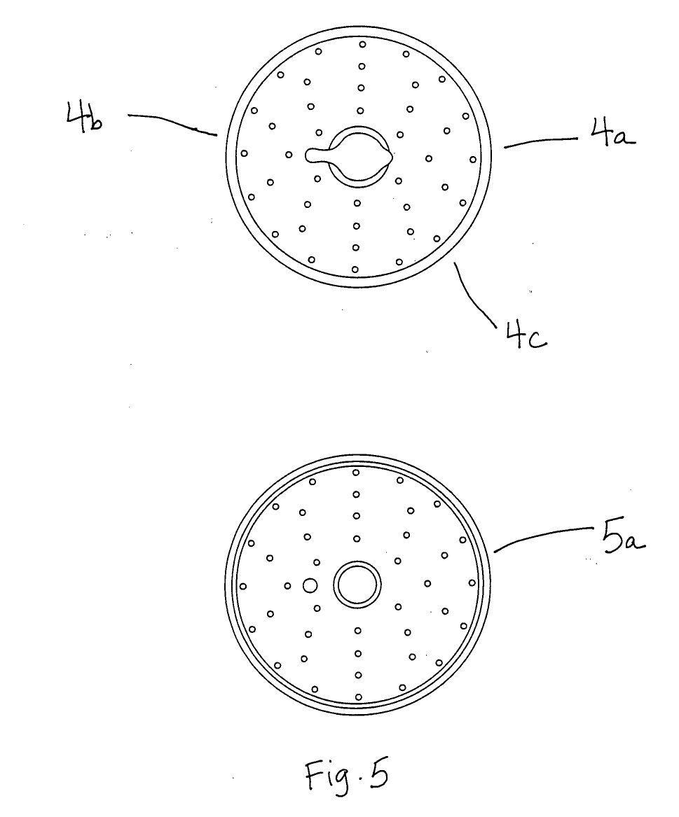

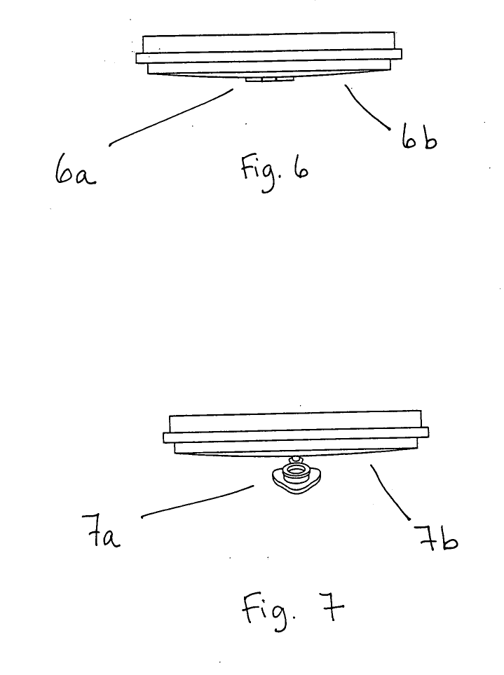

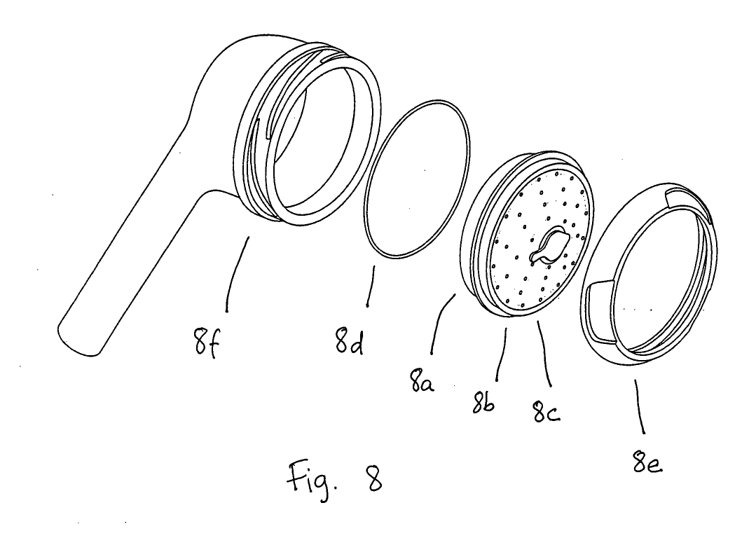

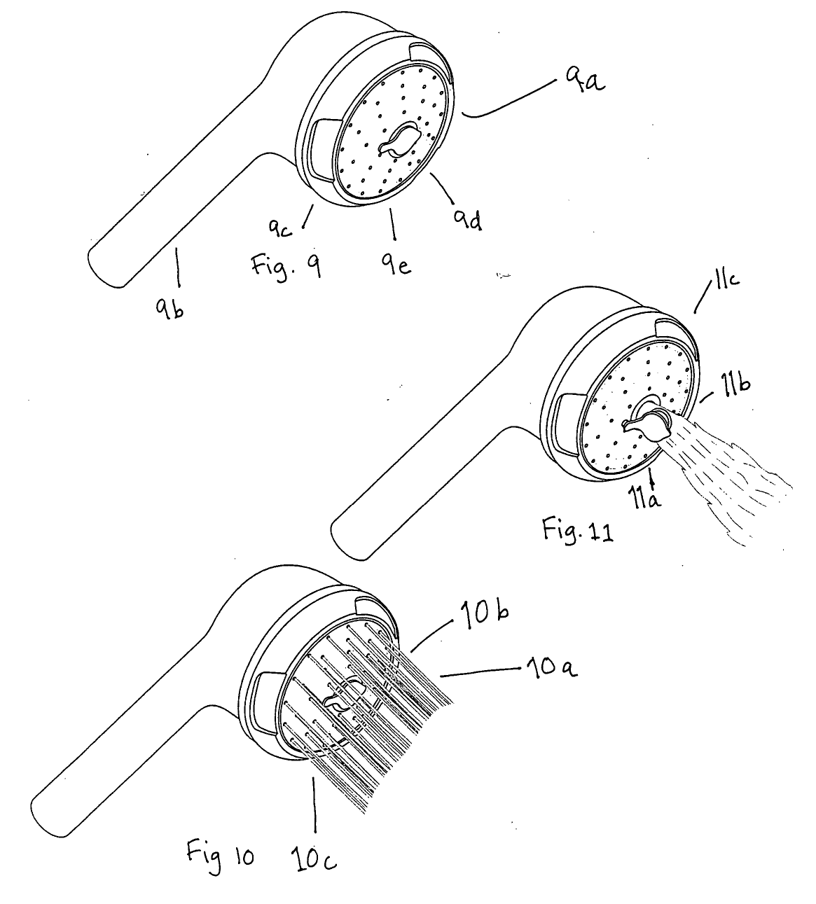

Front (exterior) view of showerhead faceplate is shown in FIG. 4 where drain hole sealing apparatus is installed into showerhead faceplate drain hole 4, thereby sealing it. Round 4c is the shape of the preferred embodiment.

Rear (interior) view of showerhead faceplate is shown in FIG. 5 where drain hole 5a is visible. This is a view from the inside of showerhead chamber where liquid reservoirs.

Side view FIG. 6 of the preferred embodiment shows drain hole sealing apparatus 6a in an installed position located in the deepest part of convex face 6b of showerhead faceplate. Convex face 6b allows liquid trapped inside showerhead chamber to reservoir.

Side view FIG. 7 of the preferred embodiment shows drain hole sealing apparatus 7a in an open position located in the deepest part of convex face 7b of showerhead faceplate. Convex face 7b would allow liquid trapped inside showerhead chamber to reservoir, while open drain hole 7a would allow said liquid to discharge.

In FIG. 8 shown are the separated components of a showerhead set incorporating the preferred embodiment of showerhead faceplate 8a. Drain hole sealing apparatus 8b seals drain hole 8c. Ring stopper 8d is to be placed between showerhead faceplate 8a and showerhead handle 8f. Threaded ring 8e it to secure showerhead faceplate 8a and ring stopper 8d to showerhead handle 8f.

In FIG. 9 shows the preferred embodiment of showerhead faceplate 9a secured to showerhead handle 9b by threaded ring 9c. Drain hole sealing apparatus 9d is installed into drain hole 9e. Showerhead chamber is the space created inside showerhead set when showerhead faceplate is secured onto showerhead handle. Assembled components 9a-9e form a showerhead set.

FIG. 10 shows the drain hole sealing apparatus 10a of the preferred embodiment installed into the drain hole 10b, thereby maintaining comfortable water pressure 10c while showering.

FIG. 11 shows the drain hole sealing apparatus 11a of the preferred embodiment in an open position allowing liquid to discharge 11b from showerhead chamber after liquid source has been shut off, thereby significantly decreasing mineral buildup inside showerhead chamber and spray holes. Convex face 11c of showerhead faceplate facilitates a complete discharge of the liquid trapped inside showerhead chamber.

### DESCRIPTION

This invention relates to a showerhead faceplate used in residential and commercial shower equipment.

What is claimed is:

1. A showerhead faceplate with a multitude of spray holes, comprising:
a) a convex face;
b) a drain hole;
c) a drain hole sealing apparatus.

2. A showerhead faceplate as defined in claim 1, wherein the shape and size fit any showerhead.

3. A showerhead faceplate as defined in claim 2, wherein the the shape is round.

4. A showerhead faceplate as defined in claim 1, wherein the material is hard plastic or any non-corrosive material.

5. A showerhead faceplate as defined in claim 1, wherein the convex face functions as a reservoir for liquid trapped inside showerhead chamber.

6. A showerhead faceplate as defined in claim 5, wherein the deepest part of the convex face is located at any area of the showerhead faceplate.

7. A showerhead faceplate as defined in claim 5, wherein the deepest part of the convex face is located at the center of the showerhead faceplate.

8. A showerhead faceplate as defined in claim 1, wherein the drain hole is located at deepest part of convex face.

9. A showerhead faceplate as defined in claim 8, wherein said drain hole is of any shape.

10. A showerhead faceplate as defined in claim 8, wherein said drain hole is round.

11. A showerhead faceplate as defined in claim 10, wherein said drain hole is threaded.

12. A showerhead faceplate as defined in claim 1, wherein the drain hole sealing apparatus is of any shape, as long as it seals said drain hole.

13. A showerhead faceplate as defined in claim 12, wherein the drain hole sealing apparatus is removable to allow discharge of liquid trapped inside showerhead chamber.

14. A showerhead faceplate as defined in claim 13, wherein the drain hole sealing apparatus is installable into said drain hole.

15. A showerhead faceplate as defined in claim 14, wherein the drain hole sealing apparatus is a rubber valve firmly but not permanently attached to showerhead faceplate, is equipped with a pull tab, and is fully detachable.

16. A showerhead faceplate as defined in claim 14, wherein the drain hole sealing apparatus forms a separate component.

17. A showerhead faceplate as defined in claim 14, wherein the drain hole sealing apparatus comes in a cork-like form.

18. A showerhead faceplate as defined in claim 1, as part of a showerhead assembly.
